(19) United States
(12) Patent Application Publication
(10) Pub. No.: US 2026/0274068 A1
(43) Pub. Date: Sep. 17, 2026

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Tatsuya Tanizawa, Nisshin-shi (JP); Akinori Shin, Toyota-shi (JP); Junichi Todaka, Seto-shi (JP); Kyosuke Nakanishi, Tokyo (JP); Hideo Hasegawa, Nagoya-shi (JP)

(73) Assignee: TOYOTA JIDOSHA KABUSHIKI KAISHA, Toyota-shi (JP)

(21) Appl. No.: 19/451,107

(22) Filed: Jan. 16, 2026

(30) Foreign Application Priority Data
Mar. 13, 2025 (JP) 2025-040523

(51) Int. Cl. B60K 35/10; B60K 35/22; G06F 3/041

(52) U.S. Cl. CPC B60K 35/10; B60K 35/22; G06F 3/0416; B60K 2360/1434; B60K 2360/161; B60K 2360/178

(57) ABSTRACT

A controller of the information processing device determines whether a warning lamp is displayed on a meter display that is disposed in front of a steering wheel and has a touch panel. The controller of the information processing device receives a touch operation on the warning lamp displayed on the meter display in a case in which the warning lamp is displayed on the meter display. The controller of the information processing device displays a meaning of the warning lamp on a side display that is disposed at a side position of the steering wheel and protrudes to a vehicle rear side with respect to the meter display in a case in which the touch operation on the warning lamp is received.

### CROSS-REFERENCE TO RELATED APPLICATION

This application claims priority to Japanese Patent Application No. 2025-040523 filed on Mar. 13, 2025. The disclosure of the above-identified application, including the specification, drawings, and claims, is incorporated by reference herein in its entirety.

### BACKGROUND

### 1. Technical Field

The present disclosure relates to an information processing device, an information processing method, and a storage medium.

### 2. Description of Related Art

Japanese Unexamined Patent Application Publication No. 2010-089653 (JP 2010-089653 A) discloses an information provision device that provides information on a warning lamp that is provided on a meter panel of a vehicle and that is turned on or blinked when an abnormality occurs in the vehicle. The information provision device informs a driver at least a meaning of the warning lamp as information on the warning lamp in a case where an abnormality does not occur in the vehicle.

### SUMMARY

An object of the present disclosure is to display a meaning of a warning lamp to be easily recognizable by a simple operation.

An information processing device according to a first aspect of the present disclosure includes

a controller configured to:

determine whether a warning lamp is displayed on a meter display disposed in front of a steering wheel and including a touch panel;

receive a touch operation on the warning lamp displayed on the meter display in a case where the warning lamp is displayed on the meter display; and

cause a side display to display a meaning of the warning lamp in a case where the touch operation on the warning lamp is received, the side display protruding toward a rear side of a vehicle with respect to the meter display and disposed at a position beside the steering wheel.

An information processing method according to a second aspect of the present disclosure is

an information processing method executed by a computer, the information processing method includes:

determining whether a warning lamp is displayed on a meter display disposed in front of a steering wheel and including a touch panel;

receiving a touch operation on the warning lamp displayed on the meter display in a case where the warning lamp is displayed on the meter display; and

causing a side display to display a meaning of the warning lamp in a case where the touch operation on the warning lamp is received, the side display protruding toward a rear side of a vehicle with respect to the meter display and disposed at a position beside the steering wheel.

A non-transitory storage medium storing a program according to a third aspect of the present disclosure is

a non-transitory storage medium storing a program for causing a computer to execute an information processing method,

the information processing method includes:

determining whether a warning lamp is displayed on a meter display disposed in front of a steering wheel and including a touch panel;

receiving a touch operation on the warning lamp displayed on the meter display in a case where the warning lamp is displayed on the meter display; and

causing a side display to display a meaning of the warning lamp in a case where the touch operation on the warning lamp is received, the side display protruding toward a rear side of a vehicle with respect to the meter display and disposed at a position beside the steering wheel.

According to the present disclosure, it is possible to display a meaning of a warning lamp to be easily recognizable by a simple operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an interior of a vehicle;

FIG. 2 is an enlarged view of a periphery of a steering wheel;

FIG. 3 is a diagram schematically showing an example of a hardware configuration of the vehicle;

FIG. 4 is a diagram illustrating a functional configuration of an ECU;

FIG. 5 is a diagram showing an example of a display of a meter display while the vehicle is not moving; and

FIG. 6 is a flowchart of processing executed by a controller.

### DETAILED DESCRIPTION OF EMBODIMENTS

A warning lamp may be displayed on a meter display of the vehicle. In this case, the user of the vehicle may not understand the meaning of the warning lamp. Therefore, the meaning of the warning lamp is displayed on a display. In this case, an operation for displaying the meaning of the warning lamp may be complicated, or the display of the meaning of the warning lamp may be difficult to see. Therefore, the information processing device according to the present disclosure solves such a problem.

A controller of the information processing device according to the present disclosure determines whether a warning lamp is displayed on a meter display that is disposed in front of a steering wheel and that has a touch panel. The controller of the information processing device according to the present disclosure receives a touch operation on the warning lamp displayed on the meter display in a case in which the warning lamp is displayed on the meter display. In a case in which the touch operation on the warning lamp is received, the controller of the information processing device displays the meaning of the warning lamp on a side display that is disposed at a position on a side of the steering wheel and that protrudes to a rear side of the vehicle more than the meter display.

As described above, in a case in which the information processing device receives the touch operation on the warning lamp displayed on the meter display, the meaning of the warning lamp is displayed on the side display. Here, the user can understand the meaning of the warning lamp by a simple operation of directly touching the warning lamp displayed on the meter display. In addition, since the side display is positioned on the side of the steering wheel while protruding to the rear side of the vehicle more than the meter display, the meaning of the warning lamp can be displayed at a hand of the user. Therefore, the user can check the meaning of the warning lamp at a position where it is easy to see. In this way, it is possible to easily display the meaning of the warning lamp by a simple operation.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure.

### Embodiment

An outline of a vehicle system according to the embodiment will be described. The vehicle system according to the present embodiment includes a vehicle 1.

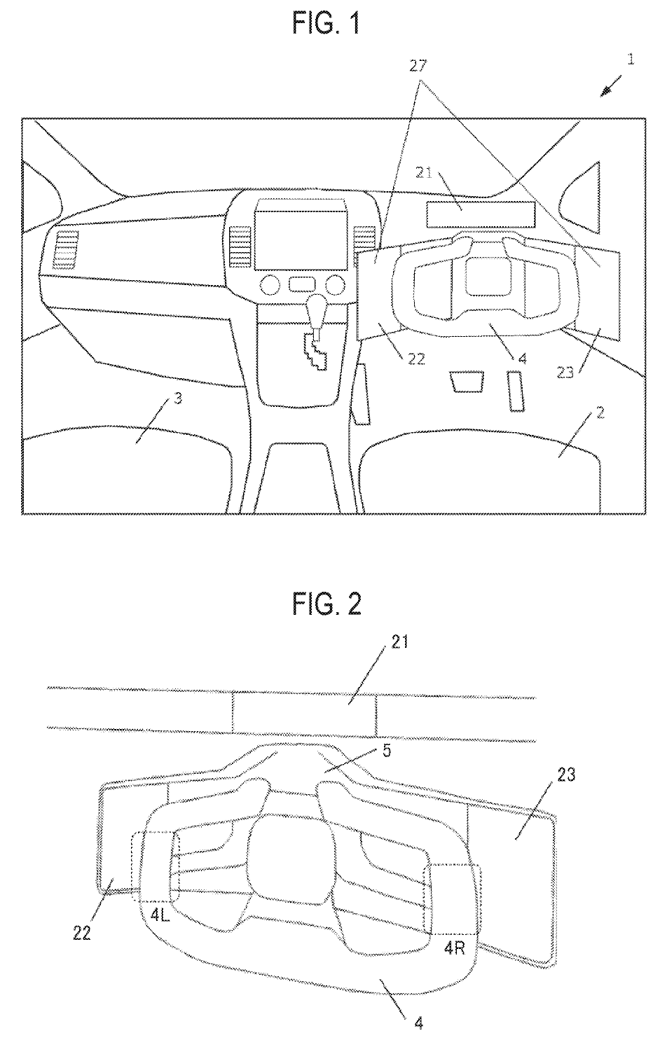

The vehicle 1 will be described with reference to FIG. 1. FIG. 1 is a diagram showing an interior of the vehicle 1. As shown in the drawing, a driver's seat 2 and a front passenger seat 3 are provided in the vehicle cabin of the vehicle 1. It should be noted that the vehicle 1 of the present embodiment is a right-hand drive vehicle, and the driver's seat 2 is provided on the right side of the vehicle 1. In addition, the front passenger seat 3 is provided on the left side of the driver's seat 2.

A steering wheel 4 is disposed on a front side of the driver's seat 2. It should be noted that the steering wheel may be circular or may be U-shaped as shown in the drawing (so-called irregular steering wheel). The steering wheel 4 is connected to a steering device provided in the vehicle 1 via a steering column. The steering column is covered with a column cover.

A meter display 21 is provided on a vehicle front side of the steering wheel 4. The meter display 21 is a full-screen display that is located in front of the driver's seat 2 and provides various kinds of information to the driver of the vehicle 1. For example, the meter display 21 displays information necessary for traveling of the vehicle, such as a vehicle speed, an engine rotation speed (in a case where the vehicle 1 has an engine), a charge/discharge status (in a case where the vehicle 1 has a drive battery), and a traveling distance. In addition, a warning lamp indicating an abnormality or a failure of the vehicle 1 or an operation mistake of the driver of the vehicle 1 is displayed on the meter display 21.

A pair of display devices 27 are provided in a front part of the driver's seat 2 in the vehicle cabin. The pair of display devices 27 includes touch panel displays that are disposed at positions on both sides of the steering wheel 4. In the present embodiment, a display disposed closer to an inside of the vehicle is referred to as an inner display, and a display disposed closer to an outside of the vehicle is referred to as an outer display. The inner display 22 and the outer display 23 are connected to an instrument panel of the vehicle 1.

The detailed structures of the inner display 22 and the outer display 23 will be described with reference to FIG. 2. FIG. 2 is an enlarged view of a periphery of the steering wheel 4. The inner display 22 and the outer display 23 are vertically elongated displays and are connected to a support portion 5 that is a member supporting each display. The support portion 5 has a shape that protrudes in a left-right direction of the steering wheel. The outer display 23 is connected to a right end part of the support portion 5 facing the vehicle front, and the inner display 22 is connected to a left end part of the support portion 5 facing the vehicle front. As a result, the display surface can be disposed near a grip portion of the steering wheel 4.

The above description is an example in a case where the vehicle 1 is a right-hand drive vehicle, and the left and right are reversed in a case where the vehicle 1 is a left-hand drive vehicle. That is, the outer display 23 is connected to a left end part of the support portion 5 facing the vehicle front, and the inner display 22 is connected to a right end part of the support portion 5 facing the vehicle front.

The support portion 5 may also serve as a column cover that covers the steering column. The support portion 5 has a shape in which each of the portions through which the steering column penetrates extends in the left-right direction (vehicle width direction), each of the portions extends to a vehicle rear side, and each of the portions is bent such that the angle with respect to the left-right direction of the steering wheel is reduced in the middle.

In addition, the inner display 22 and the outer display 23 are disposed to have an angle with respect to the left-right direction of the steering wheel and to be inclined toward the steering wheel side, respectively. That is, the inner display 22 is disposed to protrude further toward the vehicle rear side as the position is closer to the inside of the vehicle, and the outer display 23 is disposed to protrude further toward the vehicle rear side as the position is closer to the outside of the vehicle. In this manner, the inner display 22 and the outer display 23 are disposed to face the driver, respectively.

A region 4R shown by a broken line in FIG. 2 is a portion (gripping portion) of the steering wheel 4 gripped by the right hand of the driver, and a region 4L shown by a broken line in FIG. 2 is a portion (gripping portion) of the steering wheel 4 gripped by the left hand of the driver. By providing the support portion 5 having the shape described above, the positions of the inner display 22 and the outer display 23 in the vehicle front-rear direction can be brought closer to the gripping portion of the steering wheel 4. Therefore, the amount of movement of the hand in a case where the driver performs a touch operation on the inner display 22 or the outer display 23 during driving can be reduced.

The meter display 21, the inner display 22, and the outer display 23 are displays each having a touch panel. The touch panel may be provided in at least the meter display 21. As the touch panel, for example, a pressure-sensitive touch panel that detects a pressure applied to a panel by a user, and a capacitive touch panel that detects a change in electrostatic capacitance when a user presses a panel can be employed. The display is, for example, a liquid crystal display (LCD) or an electroluminescence (EL) panel.

The inner display 22 displays, for example, information related to convenience of the occupant of the vehicle 1. The information related to the convenience of the occupant of the vehicle 1 includes information for providing entertainment to the occupant of the vehicle 1. The information related to the convenience of the occupant of the vehicle 1 includes information indicating a meaning of a warning lamp displayed on the meter display 21. The information related to the convenience of the occupant of the vehicle 1 may include information related to the comfort of the occupant. The information related to the comfort and convenience of the occupant includes, for example, information related to a switch, a button, or the like for operating an audio, a navigation device, an air conditioner, a telephone, a clock, a voice assistant, or the like, or information related to an operating status of these devices.

The outer display 23 displays, for example, information related to the control of the vehicle 1. The information related to the control of the vehicle 1 includes information related to traveling of the vehicle 1. The information related to the control of the vehicle 1 includes, for example, information related to a switch, a button, or the like for operating a headlight, a wiper, a side mirror, an ADAS, a drive mode, a suspension, a position of a steering wheel, a position of a seat, or the like, or information related to an operating status of these devices. By displaying the information related to the control of the vehicle 1 on the outer display 23, the passenger other than the driver can be prevented from operating the information related to the control of the vehicle 1.

The information displayed on the inner display 22 and the outer display 23 is not limited to the above. The inner display 22 may display information related to the control of the vehicle 1, or the outer display 23 may display information related to the convenience of the occupant of the vehicle 1. In addition, the information to be displayed on the inner display 22 and the outer display 23 can be optionally determined.

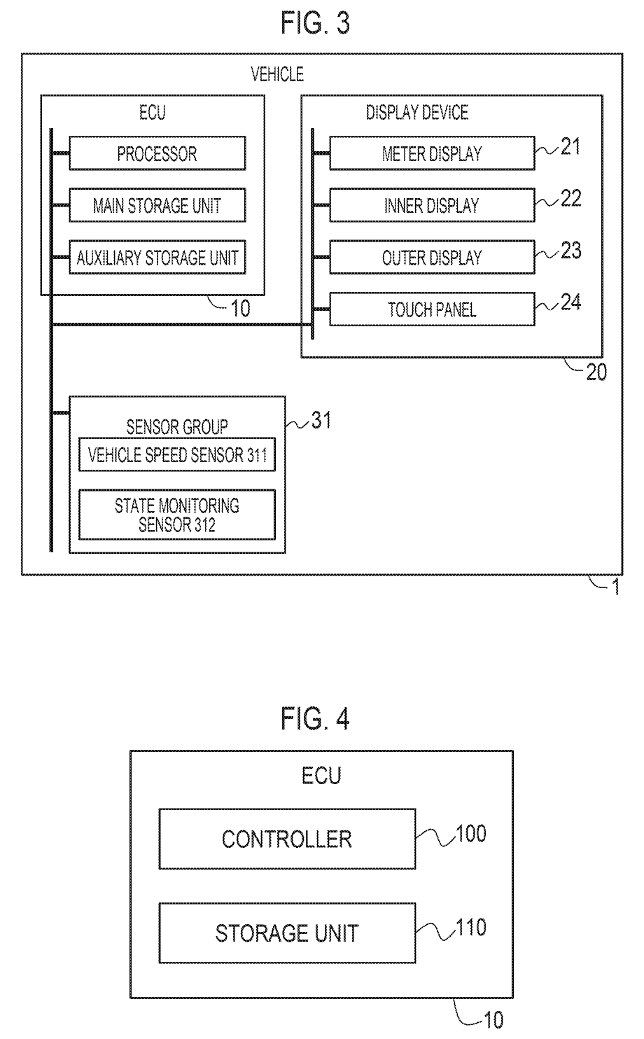

FIG. 3 is a diagram schematically showing an example of a hardware configuration of the vehicle 1. The vehicle 1 includes the ECU 10, the display device 20, and a sensor group 31. The ECU 10 can be configured as a computer including a processor (CPU, GPU, or the like), a main memory device (RAM, ROM, or the like), and an auxiliary memory device (EPROM, hard disk drive, removable medium, or the like). The auxiliary memory device stores an operating system (OS), various programs, various tables, and the like. The programs stored therein can be executed to implement each function (software module) that matches a predetermined purpose as described below. However, a part or all of the functions may be implemented as a hardware module by a hardware circuit such as an ASIC or an FPGA. The display device 20 and the sensor group 31 are connected to the ECU 10. The ECU 10 in the present embodiment is an example of an "information processing device" according to the present disclosure.

The display device 20 includes a meter display 21, an inner display 22, an outer display 23, and a touch panel 24. The touch panel 24 is a unit for detecting a touch operation performed on the meter display 21, the inner display 22, and the outer display 23. The touch panel 24 is disposed on each of the meter display 21, the inner display 22, and the outer display 23, and can be operated by touch.

The sensor group 31 is a set of a plurality of sensors for acquiring sensor data used in traveling of the vehicle 1. The sensor may acquire a physical quantity or may acquire image data or the like. The sensor group 31 includes a vehicle speed sensor 311 that detects the speed of the vehicle 1. In addition, the sensor group 31 includes a state monitoring sensor 312 that detects an abnormality or a failure of the vehicle 1, an improper operation of a driver of the vehicle 1, or the like (hereinafter, may be simply referred to as "abnormality").

### Functional Configuration

FIG. 4 is a diagram illustrating a functional configuration of the ECU 10. The ECU 10 includes a controller 100 and a storage unit 110 as functional configuration elements. The controller 100 is, for example, a functional configuration element provided by a processor executing various programs stored in the auxiliary storage unit. The storage unit 110 is a unit that stores information, and is configured to include a main storage unit and the auxiliary storage unit.

In a case where the controller 100 receives a signal indicating that the abnormality of the vehicle 1 is detected from the state monitoring sensor 312, the controller 100 displays a warning lamp corresponding to the detected abnormality on the meter display 21. In this case, the user may not understand the meaning of the warning lamp displayed on the meter display 21. Therefore, the controller 100 can receive a touch operation (hereinafter, may be simply referred to as a "touch operation") on the warning lamp displayed on the meter display 21. Here, the touch operation is an operation for displaying the meaning of the warning lamp on the inner display 22. The touch operation is, for example, a tap operation or a swipe operation on the warning lamp. The touch operation may be an operation other than the tap operation or the swipe operation on the warning lamp.

Here, in order to perform the touch operation on the warning lamp displayed on the meter display 21, the user releases the steering wheel 4 with the hand and extends the hand to the meter display 21 disposed behind the steering wheel 4. Therefore, it is not preferable to perform such an operation while the vehicle 1 is traveling. Therefore, the controller 100 disables the reception of the touch operation on the warning lamp while the vehicle 1 is not stopped.

Specifically, the controller 100 acquires the speed of the vehicle 1 from the vehicle speed sensor 311. Then, the controller 100 determines whether the speed of the vehicle 1 is greater than zero. The controller 100 determines that the vehicle 1 is not moving in a case where the speed of the vehicle 1 is zero.

In addition, the controller 100 may determine whether the vehicle 1 is stopped by a method other than the determination of whether the speed of the vehicle 1 is zero. For example, the controller 100 may determine that the vehicle 1 is stopped in a case where the shift lever of the vehicle 1 is in the parking. In addition, the controller 100 may determine that the vehicle 1 is stopped in a case where the vehicle 1 is in the accessory mode. That is, the controller 100 may determine that the vehicle 1 is stopped in a case where the vehicle 1 is in a completely stopped state.

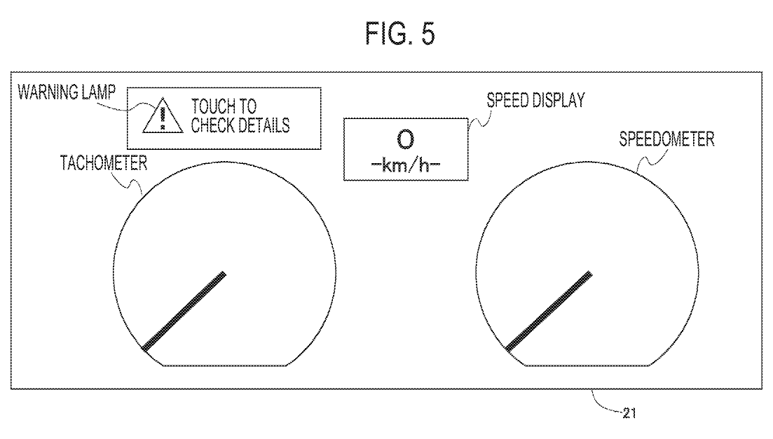

Here, the controller 100 may perform a display indicating that the touch operation on the warning lamp is possible in a case where the vehicle 1 is not moving. FIG. 5 is a diagram showing an example of the display of the meter display 21 while the vehicle 1 is not moving. In the example shown in FIG. 5, a tachometer and a speedometer are displayed on the left and right sides of the meter display 21, respectively. In addition, a speed display is displayed between the tachometer and the speedometer. Here, in the speed display, the current speed is displayed in digital form. In the example shown in FIG. 5, since the vehicle 1 is not moving, "zero" is displayed in the speed display.

In the example shown in FIG. 5, the warning lamp is displayed above the tachometer. In this case, since the vehicle 1 is not moving, a display indicating that the touch operation on the warning lamp is possible is performed on the right side of the warning lamp. In the example shown in FIG. 5, a display of "touch to check details" is performed as the display indicating that the touch operation on the warning lamp is possible, on the side of the warning lamp. As a result, the user can understand that the user can check the meaning of the warning lamp by performing the touch operation on the warning lamp. It should be noted that, in a case where the vehicle 1 is not stopped, a display indicating that the touch operation on the warning lamp is not possible may be performed.

In a case where the controller 100 receives the touch operation on the warning lamp displayed on the meter display 21, the controller 100 displays the meaning of the warning lamp displayed on the meter display 21 on the inner display 22. The controller 100 may display the meaning of the warning lamp on an entirety of the display region of the inner display 22 or on a part of the display region of the inner display 22.

In a case where the controller 100 ends the display of the warning lamp, the controller 100 disables the reception of the touch operation. Here, in a case where the controller 100 receives a signal indicating that the abnormality is not detected from the state monitoring sensor 312, the controller 100 ends the display of the warning lamp. In addition, in a case where the warning lamp displayed on the meter display 21 is the warning lamp for which the display time is set, the controller 100 may end the display of the warning lamp after the display time elapses.

In a case where the controller 100 detects the touch operation, the controller 100 outputs information (hereinafter, may be referred to as “warning lamp information”) indicating the meaning of the warning lamp that has been subjected to the touch operation to the inner display 22. As a result, the display indicating the meaning of the warning lamp is performed on the inner display 22.

### Flowchart

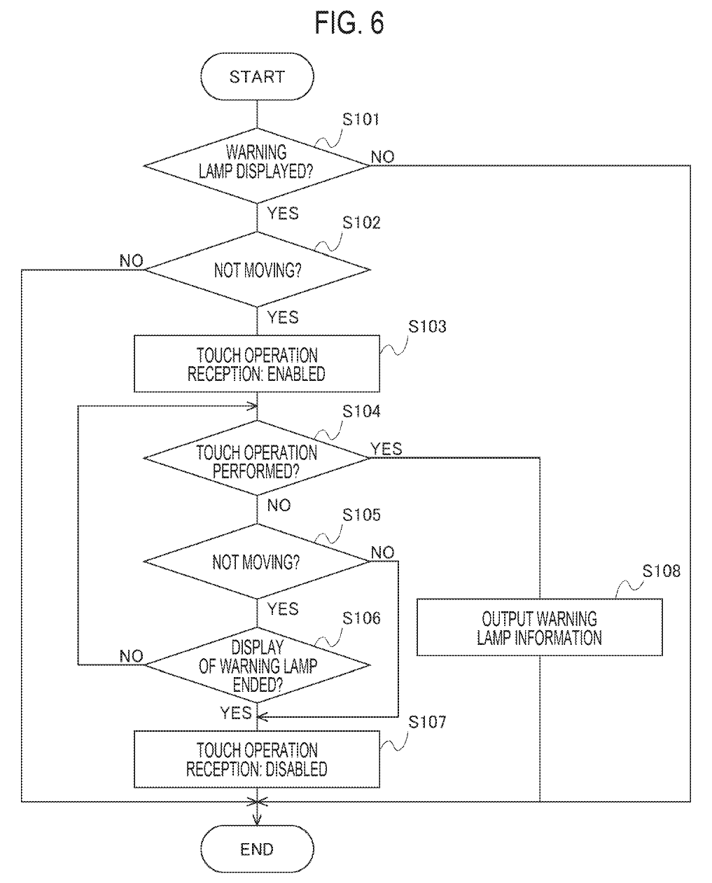

Next, a process executed by the controller 100 will be described with reference to FIG. 6. FIG. 6 is a flowchart of a process executed by the controller 100. The process is a process of displaying the meaning of the warning lamp on the inner display 22. The process is repeatedly executed at predetermined intervals.

In the process shown in FIG. 6, first, in S101, determination is made whether the warning lamp is displayed on the meter display 21. In a case where a negative determination is made in S101, since the warning lamp is not displayed, the process shown in FIG. 6 is temporarily ended. In a case where a positive determination is made in S101, the user may not understand the meaning of the warning lamp displayed on the meter display 21. Therefore, the process shown in FIG. 6 continues.

In a case where a positive determination is made in S101, in S102, determination is made whether the vehicle 1 is not moving. In a case where a negative determination is made in S102, the vehicle 1 is traveling. Therefore, the process shown in FIG. 6 is ended without being able to receive the touch operation.

In a case where a positive determination is made in S102, the warning lamp is displayed and the vehicle 1 is not moving, so that the touch operation is enabled in S103. In this case, the controller 100 displays a display indicating that the touch operation on the warning lamp can be received on the meter display 21. That is, the controller 100 displays the display of "Touch to check details" in the example shown in FIG. 5 on the right side of the warning lamp.

Next, determination is made whether the touch operation is performed on the warning lamp displayed on the meter display 21 in S104. In a case where a positive determination is made in S104, the user is trying to check the meaning of the warning lamp. Therefore, in S108, the warning lamp information is output to the inner display 22. Then, the process shown in FIG. 6 is temporarily ended.

In a case where a negative determination is made in S104, determination is made whether the vehicle 1 is not moving in S105. In a case where a negative determination is made in S105, the vehicle 1 is traveling, so that it is not suitable for the user to perform the touch operation. Therefore, in S107, the touch operation is disabled. In this case, the controller 100 ends the display indicating that the touch operation on the warning lamp is possible. Then, the process shown in FIG. 6 is temporarily ended.

In this case, after the process shown in FIG. 6 is ended, the process shown in FIG. 6 is executed again. In this case, in a case where the warning lamp is displayed on the meter display 21 and the vehicle 1 is not moving, the touch operation is enabled again in S103. In other words, in a case where the vehicle 1 travels in a case where the touch operation is possible, the touch operation is disabled, and the touch operation is disabled until the vehicle 1 is stopped in a state where the warning lamp is displayed on the meter display 21. As a result, the user can perform the touch operation in a situation suitable for performing the touch operation by the vehicle 1 being stopped.

In a case where a positive determination is made in S105, determination is made in S106 whether the display of the warning lamp is ended. In a case where a negative determination is made in S106, since the warning lamp is displayed on the meter display 21, the user may check the meaning of the warning lamp. Therefore, the process of S104 is executed again. That is, the processes from S104 to S106 are repeatedly executed until any one of the touch operation performed by the user, the traveling of the vehicle 1, and the end of the display of the warning lamp is established.

In a case where a positive determination is made in S106, the warning lamp is not displayed, and the user does not check the meaning of the warning lamp, so that the detection of the touch operation is ended in S107. In this case, the controller 100 ends also the display indicating that the touch operation on the warning lamp is possible. Then, the process shown in FIG. 6 is temporarily ended.

As described above, in the vehicle system, in a case where the touch operation on the warning lamp displayed on the meter display 21 is received, the meaning of the warning lamp is displayed on the inner display 22. Here, the user can understand the meaning of the warning lamp by a simple operation of directly touching the warning lamp displayed on the meter display 21, without performing a complicated operation. In addition, the inner display 22 is located on the side of the steering wheel 4 while protruding to the rear side of the vehicle 1 with respect to the meter display 21. Therefore, the meaning of the warning lamp can be displayed at the user's hand. That is, the meaning of the warning lamp can be checked at an easily visible position, as compared with a case where the meaning of the warning lamp is displayed on the meter display 21 or the like. In this way, it is possible to easily display the meaning of the warning lamp by a simple operation.

### Modification

In the present embodiment, the meaning of the warning lamp is displayed on the inner display 22. However, the meaning of the warning lamp does not necessarily need to be displayed on the inner display 22. The meaning of the warning lamp may be displayed on the outer display 23. In this case, the outer display 23 is located on the side of the steering wheel 4 while protruding to the rear side of the vehicle 1 with respect to the meter display 21. Therefore, even in this case, the meaning of the warning lamp can be checked at an easily visible position closer to the display of the meaning of the warning lamp on the meter display 21.

### Other Embodiments

The above embodiment is merely an example, and the present disclosure may be implemented with appropriate modifications without departing from the gist thereof. For example, the processing and means described in the present disclosure can be implemented in any combination as long as no technical inconsistencies arise.

The processing described as being performed by one device may be executed by a plurality of devices in a shared manner. Alternatively, the processing described as being performed by different devices may be executed by one device. In a computer system, a hardware configuration (server configuration) for realizing each function can be flexibly changed.

The present disclosure can also be realized by supplying a computer program in which the functions described in the above embodiment are implemented to a computer, and reading and executing the program by one or more processors possessed by the computer. Such a computer program may be provided to the computer by a non-temporary computer-readable storage medium that can be connected to the computer's system bus, or may be provided to the computer via a network. The non-temporary computer-readable storage medium includes, for example, any type of medium suitable for storing electronic commands, such as a magnetic disk (a floppy (registered trademark) disk or a hard disk drive (HDD)). The non-temporary computer-readable storage medium includes, for example, any type of medium suitable for storing electronic commands, such as any type of disk (a CD-ROM, a DVD disk, a Blu-ray disk, or the like). The non-temporary computer-readable storage medium includes, for example, any type of medium suitable for storing electronic commands, such as a read only memory (ROM), a random access memory (RAM), an EPROM, an EEPROM, a magnetic card, a flash memory, or an optical card.

What is claimed is:

1. An information processing device comprising a controller configured to:
determine whether a warning lamp is displayed on a meter display disposed in front of a steering wheel and including a touch panel;
receive a touch operation on the warning lamp displayed on the meter display in a case where the warning lamp is displayed on the meter display; and
cause a side display to display a meaning of the warning lamp in a case where the touch operation on the warning lamp is received, the side display protruding toward a rear side of a vehicle with respect to the meter display and disposed at a position beside the steering wheel.

2. The information processing device according to claim 1, wherein the controller is configured to disable reception of the touch operation on the warning lamp while the vehicle is not stopped.

3. The information processing device according to claim 1, wherein the controller is further configured to cause, in a case where the touch operation on the warning lamp is enabled, the meter display to display a display indicating that the touch operation on the warning lamp is enabled.

4. An information processing method executed by a computer, the information processing method comprising:
determining whether a warning lamp is displayed on a meter display disposed in front of a steering wheel and including a touch panel;
receiving a touch operation on the warning lamp displayed on the meter display in a case where the warning lamp is displayed on the meter display; and
causing a side display to display a meaning of the warning lamp in a case where the touch operation on the warning lamp is received, the side display protruding toward a rear side of a vehicle with respect to the meter display and disposed at a position beside the steering wheel.

5. A non-transitory storage medium storing a program for causing a computer to execute an information processing method, the information processing method comprising:
determining whether a warning lamp is displayed on a meter display disposed in front of a steering wheel and including a touch panel;
receiving a touch operation on the warning lamp displayed on the meter display in a case where the warning lamp is displayed on the meter display; and
causing a side display to display a meaning of the warning lamp in a case where the touch operation on the warning lamp is received, the side display protruding toward a rear side of a vehicle with respect to the meter display and disposed at a position beside the steering wheel.
